(19) United States
(12) Patent Application Publication
(10) Pub. No.: US 2026/0298107 A1
(43) Pub. Date: Oct. 1, 2026

(54) SYSTEM AND METHOD FOR AIRCRAFT ENGINE WASHING

(71) Applicant: PRATT & WHITNEY CANADA CORP., Longueuil (CA)

(72) Inventors: Sebastien BERGERON, St-Bruno-De-Montarville (CA); Patrick MANOUKIAN, Longueuil (CA)

(21) Appl. No.: 19/093,671

(22) Filed: Mar. 28, 2025

(51) Int. Cl. F01D 25/00

(52) U.S. Cl. CPC F01D 25/002; F05D 2220/323; F05D 2260/607; F05D 2260/608

(57) ABSTRACT

A method for washing an aircraft engine including a compressor having variable guide vanes pivotable about respective spanwise axes and having a secondary air system in fluid communication with the compressor via a bleed outlet located downstream of the variable guide vanes, the method includes: injecting a washing fluid into the compressor of the aircraft engine; while the compressor is rotating at a rotational speed, pivoting the variable guide vanes about their respective spanwise axes to a purging position at which an air pressure at the bleed outlet is maximal for the rotational speed of the compressor; and after the injecting of the washing fluid, expelling the washing fluid out of the secondary air system by injecting air in the bleed outlet with the compressor being in rotation while the variable guide vanes are in the purging position.

### TECHNICAL FIELD

The disclosure relates generally to aircraft engines and, more particularly, to systems and methods used to wash internal components, such as compressors, of such engines to remove impurities therefrom.

### BACKGROUND

Aircraft engines, such as gas turbine engines, have compressors that compress air before feeding compressed air to a combustor. In use, various impurities such as dust, salt, and sand may accumulate in the compressors during flight. With time, the accumulated impurities may affect efficiency of the aircraft engines. Although existing systems and methods for washing compressors are satisfactory for their intended purposes, improvements are sought.

### SUMMARY

In one aspect, there is provided a method for washing an aircraft engine including a compressor having variable guide vanes pivotable about respective spanwise axes and having a secondary air system in fluid communication with the compressor via a bleed outlet located downstream of the variable guide vanes, the method comprising: injecting a washing fluid into the compressor of the aircraft engine; while the compressor is rotating at a rotational speed, pivoting the variable guide vanes about their respective spanwise axes to a purging position at which an air pressure at the bleed outlet is maximal for the rotational speed of the compressor; and after the injecting of the washing fluid, expelling the washing fluid out of the secondary air system by injecting air in the bleed outlet with the compressor being in rotation while the variable guide vanes are in the purging position.

The method described above may include any of the following features, in any combinations.

In some embodiments, the pivoting of the variable guide vanes from a current position to the purging position includes: receiving a signal indicative of a current position of the variable guide vanes; and pivoting the variable guide vanes based on a difference between the current position and the purging position.

In some embodiments, the method includes determining the purging position of the variable guide vane based on the rotational speed of the compressor and based on actual ambient conditions in which the aircraft engine is being operated.

In some embodiments, the determining of the purging position includes determining the purging position from a lookup table associating variable guide vane purging positions to rotational speeds of the compressor and to ambient conditions in which the aircraft engine is operated.

In some embodiments, the method includes rotating the compressor during the injecting of the washing fluid.

In some embodiments, the rotating of the compressor includes rotating the compressor while the aircraft engine is shut down.

In some embodiments, the rotating of the compressor includes powering an actuator drivingly engaged to a shaft of the aircraft engine.

In some embodiments, the powering of the actuator includes powering an engine starter of the aircraft engine.

In some embodiments, the expelling of the washing fluid out of the secondary air system includes maintaining the compressor in rotation for about 30 seconds to 60 seconds.

In some embodiments, the expelling of the washing fluid out of the secondary air system includes expelling the washing fluid out of one or more of a cooling system of the aircraft engine and a pressurization system of the aircraft engine.

In another aspect, there is provided an aircraft engine, comprising: an engine core having a compressor, a combustor downstream of the compressor relative to a gas flow through the engine core, and a turbine downstream of the combustor, the compressor including: variable guide vanes being pivotable about respective spanwise axes; and a bleed outlet downstream of the variable guide vanes relative to a gas flow through the aircraft engine; a secondary air system fluidly connected to the bleed outlet of the compressor; and a controller having a processing unit and a computer-readable medium having instructions stored thereon executable by the processing unit to, during washing of the aircraft engine: cause the compressor to rotate at a rotational speed; pivot the variable guide vanes about their respective spanwise axes to a purging position at which an air pressure at the bleed outlet is maximal for the rotational speed of the compressor; and cause the compressor to continue to rotate at the rotational speed while the variable guide vanes are in the purging position to expel a washing fluid out of the secondary air system by injecting air from the compressor into the bleed outlet.

The aircraft engine described above may include any of the following features, in any combinations.

In some embodiments, the computer-readable medium has the instructions stored thereon executable by the processing unit to: cause the compressor to rotate while the washing fluid is being injected in the compressor.

In some embodiments, the computer-readable medium further has instructions stored thereon executable by the processing unit to: determine the purging position of the variable guide vane based on the rotational speed of the compressor and based on actual ambient conditions in which the aircraft engine is being operated.

In some embodiments, the computer-readable medium has the instructions stored thereon executable by the processing unit to: determine the purging position from a lookup table associating variable guide vane purging positions to rotational speeds of the compressor and to ambient conditions in which the aircraft engine is operated.

In some embodiments, the computer-readable medium has the instructions stored thereon executable by the processing unit to pivot the variable guide vanes from a current position to the purging position by: receiving a signal indicative of a current position of the variable guide vanes; and pivoting the variable guide vanes based on a difference between the current position and the purging position.

In some embodiments, the computer-readable medium has the instructions stored thereon executable by the processing unit to cause the compressor to rotate by: inducing rotation of the compressor while the aircraft engine is shut down.

In some embodiments, the computer-readable medium has the instructions stored thereon executable by the processing unit to induce the rotation of the compressor by: powering an actuator drivingly engaged to a shaft of the aircraft engine.

In some embodiments, the computer-readable medium has the instructions stored thereon executable by the processing unit to power the actuator by: powering an engine starter of the aircraft engine.

In some embodiments, the computer-readable medium has the instructions stored thereon executable by the processing unit to cause the compressor to continue to rotate for a given period of time by: maintaining the compressor in rotation for about 30 seconds to 60 seconds.

In yet another aspect, there is provided a method for mitigating an accumulation of a washing fluid in a secondary air system of an aircraft engine following an engine wash, the aircraft engine having a compressor including variable guide vanes pivotable about spanwise axes and located upstream of a bleed outlet of the compressor, the method comprising: rotating the compressor at a rotational speed; pivoting the variable guide vanes of the compressor to a purging position for maximizing a pressure at the bleed outlet for the rotational speed; and expelling the washing fluid out of the secondary air system by injecting air in the secondary air system with the compressor rotating at the rotational speed with the variable guide vane in the purging position.

### BRIEF DESCRIPTION OF THE DRAWINGS

Reference is now made to the accompanying figures in which:

FIG. 1 is a schematic cross-sectional view of an aircraft engine depicted as a gas turbine engine;

FIG. 2 is a schematic view of a portion of a compressor of the gas turbine engine of FIG. 1;

FIG. 3 is a flowchart illustrating steps of a method for washing the gas turbine engine of FIG. 1;

FIG. 4 is a flowchart illustrating steps of another method for washing the gas turbine engine of FIG. 1;

FIG. 5 is a flowchart illustrating steps of a method for mitigating an accumulation of a washing fluid in a secondary air system of the gas turbine engine of FIG. 1;

FIG. 6 illustrates a table correlating angular positions of variable guide vanes of the compressor to rotational speeds of the compressor and to ambient conditions; and

FIG. 7 is a diagram illustrating a logic performed by the gas turbine engine of FIG. 1 during washing; and

FIG. 8 is a schematic representation of a controller for the gas turbine engine of FIG. 1.

### DETAILED DESCRIPTION

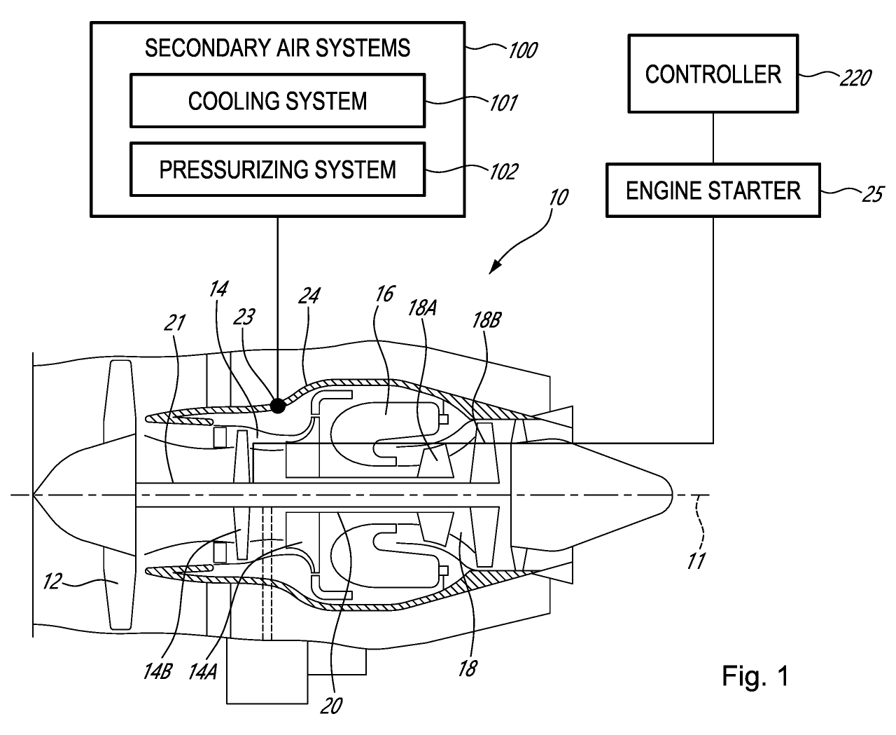

FIG. 1 illustrates an aircraft engine depicted as a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The fan 12, the compressor section 14, and the turbine section 18 are rotatable about a central axis 11 of the gas turbine engine 10. In the embodiment shown, the gas turbine engine 10 comprises a high-pressure spool having a high-pressure shaft 20 drivingly engaging a high-pressure turbine 18A of the turbine section 18 to a high-pressure compressor 14A of the compressor section 14, and a low-pressure spool having a low-pressure shaft 21 drivingly engaging a low-pressure turbine 18B of the turbine section to a low-pressure compressor 14B of the compressor section 14 and drivingly engaged to the fan 12. It will be understood that the contents of the present disclosure may be applicable to any suitable engines, such as turboprops and turboshafts, and reciprocating engines, such as piston and rotary engines without departing from the scope of the present disclosure.

The gas turbine engine 10 has secondary air systems 100, which include, for instance, a pressurizing system 101 configured for pressurizing bearing cavities of the gas turbine engine 10 and a cooling system 102 configured for injecting cooling air to cool down shrouds of the turbine section 18 of the gas turbine engine 10. Other secondary air systems may be used in some embodiments. The compressor section 14 has a bleed outlet 23 defined through a casing 24 and used to extract compressed air from the compressor section 14 to feed the secondary air systems described above.

In use, impurities such as salt, dust, and sand may accumulate in the compressors and more specifically on blades of the compressors. The combination of salt and sulfide, which are commonly found in aviation fuels, can lead to a process known as sulfidation in the hot sections of the gas turbine engine. Sulfidation results in the corrosion of engine parts. Additionally, even when the engine is not operational, salt can cause rust and pimples. Magnesium components, including the compressor air intake housing and the gearbox bearing, are also susceptible to salt. Over time, this corrosion may affect engine efficiency, shortens service life, and escalates operating costs. Moreover, accumulation of these impurities may disrupt the flow of air through the engine, which can lead an increase in fuel consumption and rise in temperature.

Periodically performing a compressor wash is used to remove these impurities. However, the water or other washing fluid used for these washes may get into the cavities and stagnates. If the water remains for a prolonged period in those cavities, it may lead to corrosion of some components, such as the bearings. Stated differently, during washing of the gas turbine engine 10, the washing fluid may accumulate in the secondary air systems 100, which may be undesirable. The present disclosure pertains to a method of washing the compressor that may at least partially alleviate the aforementioned drawbacks.

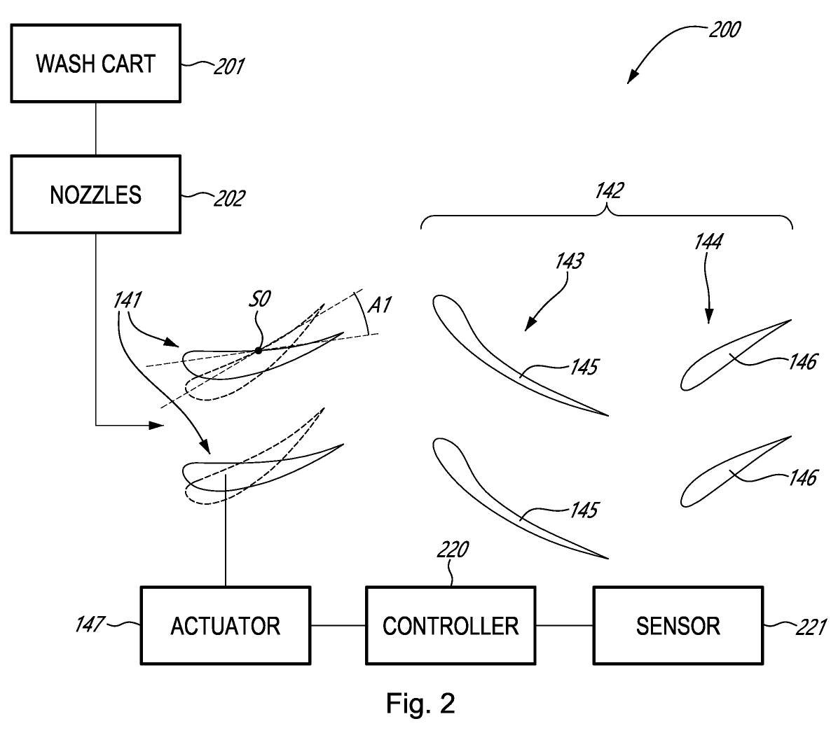

Referring to FIG. 2, a system for washing the gas turbine engine 10 is illustrated at 200. The system 200 includes a wash cart 201 that supplies a washing fluid, such as water or other suitable fluid, to nozzles 202. A manifold may be used to split the washing fluid between the nozzles 202. The nozzles 202 are aimed at the gas turbine engine 10 to inject the washing fluid at a plurality of locations into the gas turbine engine 10. In some embodiments, the gas turbine engine 10 is shut down, but the compressor section 14 is in rotation to facilitate the penetration of the washing fluids through the gas turbine engine 10. An engine starter 25 (FIG. 1) may be driving engaged to a shaft, such as the low-pressure shaft 21 and/or the high-pressure shaft 20 to cause rotation of the compressor section 14. 1 The engine starter 25 may be an electric motor or a pneumatic starter.

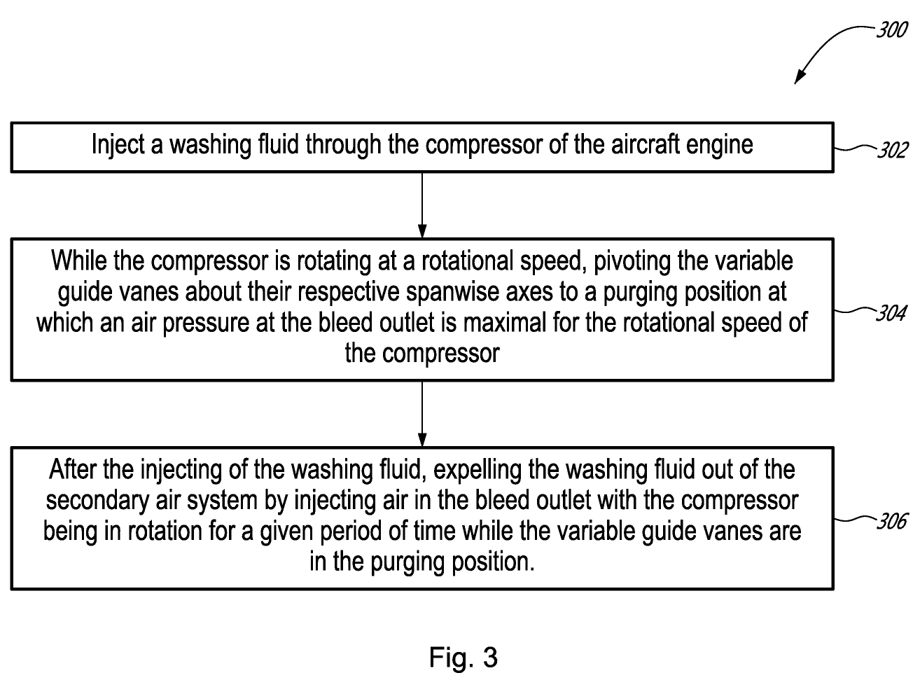

As illustrated in FIG. 2, the compressor section 14 includes variable guide vanes 141 circumferentially distributed around the central axis 11 and one or more compressor stages 142, only one shown in FIG. 3 for clarity, located downstream of the variable guide vanes 141. Herein, the expressions “upstream” and “downstream” are in relation to a gas flow through the gas turbine engine 10, that is, through the compressor, combustor, and turbine. Each of the compressor stages 142 include a rotor 143 and a stator 144, herein downstream of the rotor 143. The rotor 143 includes blades 145 circumferentially distributed about the central axis 11 and the stator 144 includes vanes 146 circumferentially distributed about the central axis 11. The variable guide vanes 141 are pivotable about respective spanwise axes S0 to change an orientation of a flow meeting the compressor stage 142 downstream of the variable guide vanes 141.

The variable guide vanes 141 are controlled by an actuator 147 drivingly engaged to the variable guide vanes 141. In some embodiments, the actuator 147 is engaged to a unison ring that is engaged to each of the vanes 146. Hence, rotation of the unison ring about the central axis 11 will cause synchronous pivoting of the vanes 146 about their respective spanwise axes S0. The actuator 147 is operatively connected to a controller 220 that causes the powering of the actuator 147. To determine the position of the variable guide vanes 141, a sensor 221, which may be a linear variable differential transformer (LVTD), is used. The sensor 221 is used to sense a position of the variable guide vanes 141 and to supply information to the controller 220 about said position. This information is supplied to the controller 220 to determine how to move the vanes 146 to achieve a desired position. The controller 220 may receive successive feedback from the sensor 221 indicative of the position of the variable guide vanes 141 and once the signal from the sensor 221 is indicative that the position of the variable guide vanes 141 corresponds to the desired position, the controller 220 will cause the variable guide vanes 141 to maintain this position.

However, during the washing of the gas turbine engine 10, some of the washing fluid may make its way into the secondary air systems 100 via the bleed outlet 23. The inventors of the present disclosure discovered a way to at least partially purge the secondary air systems 100 of the washing fluid by increasing a pressure at the bleed outlet 23. Compressed air will then flow through the secondary air systems 100 to remove at least a portion of the washing fluid. It will be appreciated that the compressor section 14 is rotating during the washing process. However, the gas turbine engine 10 may be powered off. To rotate the gas turbine engine 10, the engine starter 25 of the gas turbine engine 10 is drivingly engaged to a shaft of the gas turbine engine 10. The engine starter 25 may be any suitable actuator, such as an electric motor or a pneumatic or hydraulic actuator. Hence, it is possible to induce rotation of the compressor section 14 with the engine starter 25 during the washing process. Having the compressor section 14 rotate during the washing process may help in ensuring adequate flowing of the washing fluid across all components of the gas turbine engine 10.

Once the injection of the washing fluid is stopped, it is possible to change the orientation of the variable guide vanes 141 to maximize a pressure at the bleed outlet 23 for the rotational speed of the compressor section 14. Then, the compressor section 14 may be maintained in rotation for a given period of time to ensure that sufficient air is injected in the secondary air systems 100 to purge them of the washing fluid.

Referring to FIG. 3, a method for washing the gas turbine engine 10 is shown at 300. The method 300 includes injecting a washing fluid through the compressor section 14 of the gas turbine engine 10 at 302; while the compressor section 14 is rotating at a rotational speed, pivoting the variable guide vanes 141 about their respective spanwise axes S0 to a purging position at which an air pressure at the bleed outlet 23 is maximal for the rotational speed of the compressor section 14 at 304; and after the injecting of the washing fluid, expelling the washing fluid out of the secondary air system 100 by injecting air in the bleed outlet 23 with the compressor section 14 being in rotation for a given period of time while the variable guide vanes 141 are in the purging position at 306.

In some embodiments, the method 300 includes pivoting of the variable guide vanes 141 from a current position to the purging position by: receiving a signal indicative of a current position of the variable guide vanes 141; and pivoting the variable guide vanes 141 based on a difference between the current position and the purging position. The signal may be provided by the sensor 221 as described above.

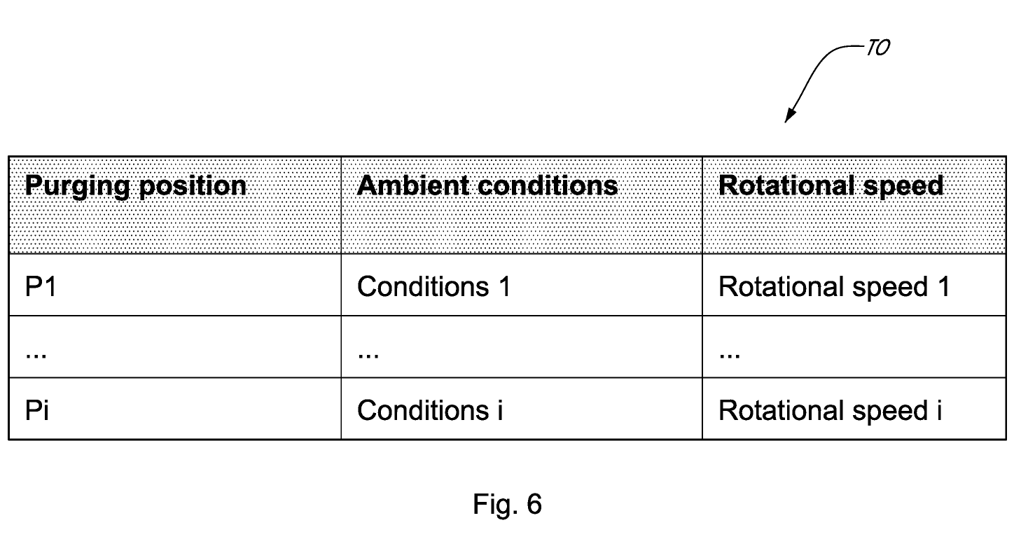

The method 300 may include determining the purging position of the variable guide vane 141 based on the rotational speed of the compressor section 14 and based on actual ambient conditions in which the aircraft engine is being operated. The ambient conditions include, for instance, one or more of outside temperature, relative humidity, wind speed, and so on. As shown in FIG. 6, a lookup table T0 may be loaded on the controller 220. The lookup table T0 may associate variable guide vane bpurging positions to rotational speeds of the compressor section 14 and to the ambient conditions in which the aircraft engine is operated. The controller 220 may then input the rotational speed of the compressor section 14 and the ambient conditions in the lookup table T0 to output the optimal purging position for these conditions.

In some embodiments, the compressor section 14 is rotating while the washing fluid is being injected. This may be achieved by rotating the compressor section 14 while the gas turbine engine 10 is shut down. The controller 220 may power the engine starter 25 to do so. In some other cases, the rotating of the gas turbine engine 10 may be induced by another actuator external to the gas turbine engine 10.

Once the injection of the washing fluid is halted, the method 300 may include expelling the washing fluid out of the secondary air systems 100 by maintaining the compressor section 14 in rotation for about 30 seconds to 60 seconds.

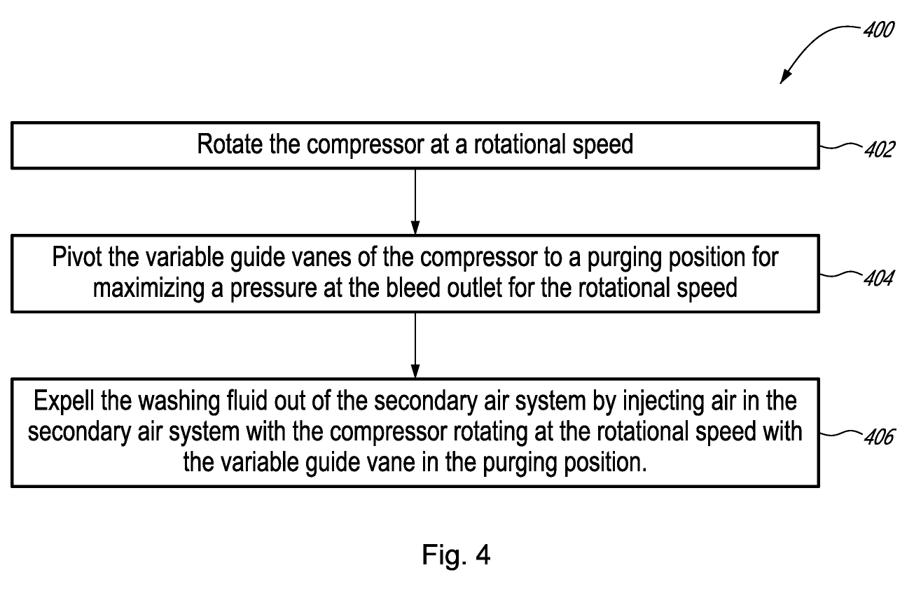

Referring now to FIG. 4, a method that may be implemented in the controller 220 is shown at 400. The method 400 may be performed during a washing process of the gas turbine engine 10. The method 400 includes: cause the compressor section 14 to rotate at a rotational speed at 402; pivot the variable guide vanes 141 about their respective spanwise axes S0 to a purging position at which an air pressure at the bleed outlet 23 is maximal for the rotational speed of the compressor section 14 at 404; and cause the compressor section 14 to continue to rotate at the rotational speed while the variable guide vanes 141 are in the purging position for a given period of time to expel the washing fluid out of the secondary air systems 100 by injecting air from the compressor section 14 into the bleed outlet 23 at 406. The other features described above with reference to the method 300 of FIG. 3 also apply to the method 400 and are not repeated below for conciseness.

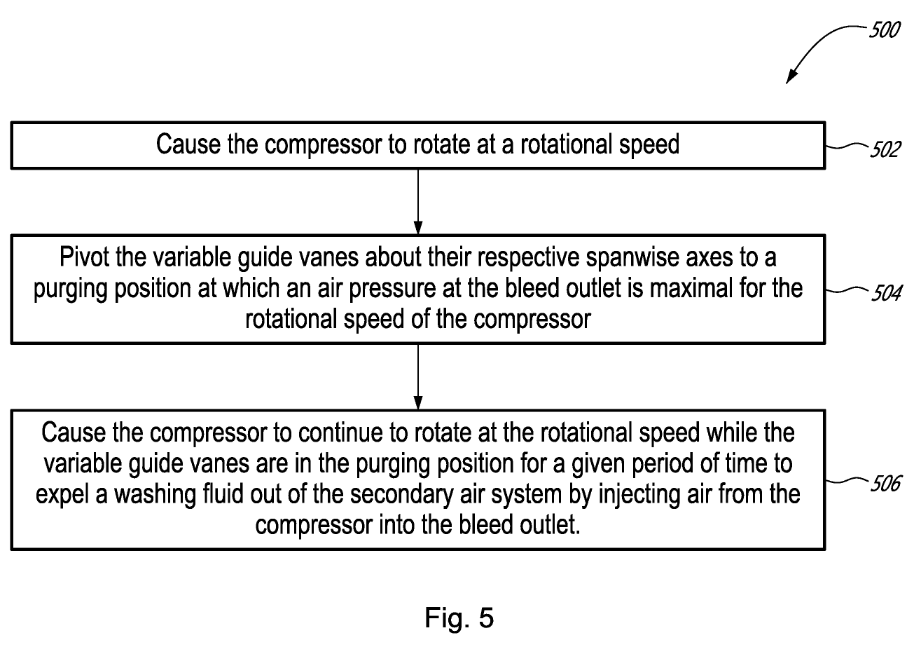

Referring now to FIG. 5, a method of mitigating an accumulation of the washing fluid in the secondary air systems 100 of the gas turbine engine 10 following an engine wash is shown at 500. The method 500 includes: rotating the compressor section 14 at a rotational speed at 502; pivoting the variable guide vanes 141 to a purging position for maximizing a pressure at the bleed outlet 23 for the rotational speed at 404; and expelling the washing fluid out of the secondary air systems 100 by injecting air in the secondary air systems 100 with the compressor section 14 rotating at the rotational speed with the variable guide vanes 141 in the purging position at 406. The other features described above with reference to the method 300 of FIG. 3 also apply to the method 500 and are not repeated below for conciseness.

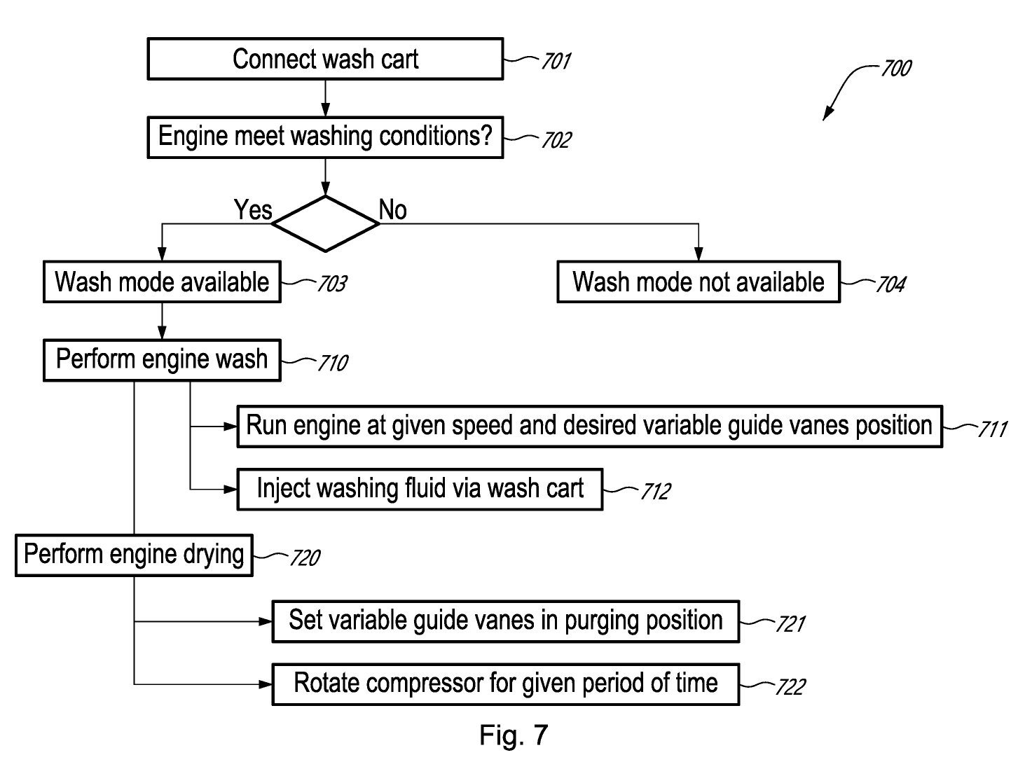

Referring now to FIG. 7, a wash logic for the gas turbine engine 10 is illustrated 700. The steps present in the wash logic may be performed by the controller 220 of the gas turbine engine 10. The logic 700 includes a step of determining that the engine/aircraft equipped with said engine is on the ground. Once this condition is met, the wash cart 201 may be connected to the gas turbine engine 10 at 701.

The controller 220 checks if all required operational conditions are met at 702. These conditions include the absence of critical engine and FADEC faults, the disabling of accessory gearbox and environmental control system bleed loads, and the confirmation of the availability of the aircraft electrical power system and autopilot status. Additionally, the main rotor speed reference must be set to normal or the most efficient speed, and the engine may be coupled to the main rotor (not in autorotation mode). The aircraft torque limiter selection may also be set to normal or high torque.

Then, if all of the conditions are met, a notification that the wash mode is available may be issued at 703. In the contrary, a notification that the wash mode is not available may be issued at 704.

If the wash mode is available, the engine wash may be performed at 710. During the wash mode, the engine may be operated in fuel mode or in assisted mode. In fuel mode, fuel is injected in the combustion chamber and the different components of the gas turbine engine 10 are rotating as a result of combustion. In the assisted move, as described above, the engine starter or other actuator is used to induce rotation of the different components of the gas turbine engine 10. In the fuel mode, the appropriate guide vane position and engine speed may be set at 711 to protect secondary air systems. The controller 220 may offers options for the variable guide vane (VGV) schedule, including a standard engine operating VGV schedule, an intermediate phase VGV schedule, and a compressor wash VGV schedule. Washing fluid is then introduced at 712 into the gas turbine engine 10 to perform the washing. If the engine is running with an electric generator, that is, in the assisted mode, the variable guide vanes may be set in a different position and the washing fluid may be introduced. After the wash, the engine performs an engine drying at 720. The position of the variable guide vanes may be set in the purging position described above at 721 and the compressor may be rotated at 722 for a given period of time.

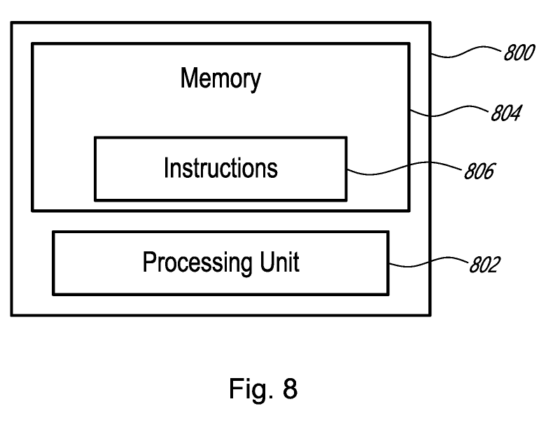

With reference to FIG. 8, an example of a computing device 800 is illustrated. For simplicity only one computing device 800 is shown but the system may include more computing devices 800 operable to exchange data. The computing devices 800 may be the same or different types of devices. The controller 220 may be implemented with one or more computing devices 800. Note that the controller 220 can be implemented as part of a full-authority digital engine controls (FADEC) or other similar device, including electronic engine control (EEC), engine control unit (ECU), electronic propeller control, propeller control unit, and the like. In some embodiments, the controller 220 is implemented as a Flight Data Acquisition Storage and Transmission system, such as a FAST^{TM} system. The controller 220 may be implemented in part in the FAST^{TM} system and in part in the EEC. Other embodiments may also apply.

The computing device 800 comprises a processing unit 802 and a memory 804 which has stored therein computer-executable instructions 806. The processing unit 802 may comprise any suitable devices configured to implement the method described herein such that instructions 806, when executed by the computing device 800 or other programmable apparatus, may cause the functions/acts/steps performed as part of the method as described herein to be executed. The processing unit 802 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 804 may comprise any suitable known or other machine-readable storage medium. The memory 804 may comprise non-transitory computer readable storage medium, for example, but not limited to, an electronic, magnetic, optical, electromagnetic, infrared, or semiconductor system, apparatus, or device, or any suitable combination of the foregoing. The memory 804 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may comprise any storage means (e.g., devices) suitable for retrievably storing machine-readable instructions 806 executable by processing unit 802.

The methods and systems described herein may be implemented in a high level procedural or object oriented programming or scripting language, or a combination thereof, to communicate with or assist in the operation of a computer system, for example the computing device 800. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 802 of the computing device 800, to operate in a specific and predefined manner to perform the functions described herein, for example those described in the method described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or "coupled to" may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or "coupled to" may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A method for washing an aircraft engine including a compressor having variable guide vanes pivotable about respective spanwise axes and having a secondary air system in fluid communication with the compressor via a bleed outlet located downstream of the variable guide vanes, the method comprising:
injecting a washing fluid into the compressor of the aircraft engine;
while the compressor is rotating at a rotational speed, pivoting the variable guide vanes about their respective spanwise axes to a purging position at which an air pressure at the bleed outlet is maximal for the rotational speed of the compressor; and
after the injecting of the washing fluid, expelling the washing fluid out of the secondary air system by injecting air in the bleed outlet with the compressor being in rotation while the variable guide vanes are in the purging position.

2. The method of claim 1, wherein the pivoting of the variable guide vanes from a current position to the purging position includes:
receiving a signal indicative of a current position of the variable guide vanes; and
pivoting the variable guide vanes based on a difference between the current position and the purging position.

3. The method of claim 1, comprising determining the purging position of the variable guide vane based on the rotational speed of the compressor and based on actual ambient conditions in which the aircraft engine is being operated.

4. The method of claim 3, wherein the determining of the purging position includes determining the purging position from a lookup table associating variable guide vane purging positions to rotational speeds of the compressor and to ambient conditions in which the aircraft engine is operated.

5. The method of claim 1, comprising rotating the compressor during the injecting of the washing fluid.

6. The method of claim 5 wherein the rotating of the compressor includes rotating the compressor while the aircraft engine is shut down.

7. The method of claim 6, wherein the rotating of the compressor includes powering an actuator drivingly engaged to a shaft of the aircraft engine.

8. The method of claim 7, wherein the powering of the actuator includes powering an engine starter of the aircraft engine.

9. The method of claim 1, wherein the expelling of the washing fluid out of the secondary air system includes maintaining the compressor in rotation for about 30 seconds to 60 seconds.

10. The method of claim 1, wherein the expelling of the washing fluid out of the secondary air system includes expelling the washing fluid out of one or more of a cooling system of the aircraft engine and a pressurization system of the aircraft engine.

11. An aircraft engine, comprising:
an engine core having a compressor, a combustor downstream of the compressor relative to a gas flow through the engine core, and a turbine downstream of the combustor, the compressor including:
variable guide vanes being pivotable about respective spanwise axes; and
a bleed outlet downstream of the variable guide vanes relative to a gas flow through the aircraft engine;
a secondary air system fluidly connected to the bleed outlet of the compressor; and
a controller having a processing unit and a computer-readable medium having instructions stored thereon executable by the processing unit to,
during washing of the aircraft engine:
cause the compressor to rotate at a rotational speed;
pivot the variable guide vanes about their respective spanwise axes to a purging position at which an air pressure at the bleed outlet is maximal for the rotational speed of the compressor; and
cause the compressor to continue to rotate at the rotational speed while the variable guide vanes are in the purging position to expel a washing fluid out of the secondary air system by injecting air from the compressor into the bleed outlet.

12. The aircraft engine of claim 11, wherein the computer-readable medium has the instructions stored thereon executable by the processing unit to:
cause the compressor to rotate while the washing fluid is being injected in the compressor.

13. The aircraft engine of claim 11, wherein the computer-readable medium further has instructions stored thereon executable by the processing unit to:
determine the purging position of the variable guide vane based on the rotational speed of the compressor and based on actual ambient conditions in which the aircraft engine is being operated.

14. The aircraft engine of claim 13, wherein the computer-readable medium has the instructions stored thereon executable by the processing unit to:
determine the purging position from a lookup table associating variable guide vane purging positions to rotational speeds of the compressor and to ambient conditions in which the aircraft engine is operated.

15. The aircraft engine of claim 11, wherein the computer-readable medium has the instructions stored thereon executable by the processing unit to pivot the variable guide vanes from a current position to the purging position by:
receiving a signal indicative of a current position of the variable guide vanes; and
pivoting the variable guide vanes based on a difference between the current position and the purging position.

16. The aircraft engine of claim 11, wherein the computer-readable medium has the instructions stored thereon executable by the processing unit to cause the compressor to rotate by:
inducing rotation of the compressor while the aircraft engine is shut down.

17. The aircraft engine of claim 16, wherein the computer-readable medium has the instructions stored thereon executable by the processing unit to induce the rotation of the compressor by:
powering an actuator drivingly engaged to a shaft of the aircraft engine.

18. The aircraft engine of claim 17, wherein the computer-readable medium has the instructions stored thereon executable by the processing unit to power the actuator by:
powering an engine starter of the aircraft engine.

19. The aircraft engine of claim 11, wherein the computer-readable medium has the instructions stored thereon executable by the processing unit to cause the compressor to continue to rotate for a given period of time by:
maintaining the compressor in rotation for about 30 seconds to 60 seconds.

20. A method for mitigating an accumulation of a washing fluid in a secondary air system of an aircraft engine following an engine wash, the aircraft engine having a compressor including variable guide vanes pivotable about spanwise axes and located upstream of a bleed outlet of the compressor, the method comprising:
rotating the compressor at a rotational speed;
pivoting the variable guide vanes of the compressor to a purging position for maximizing a pressure at the bleed outlet for the rotational speed; and
expelling the washing fluid out of the secondary air system by injecting air in the secondary air system with the compressor rotating at the rotational speed with the variable guide vane in the purging position.
